(19) United States
(12) Patent Application Publication
(10) Pub. No.: US 2001/0038491 A1
(43) Pub. Date: Nov. 8, 2001

(54) Modular 3-D shutter glasses and method

(76) Inventor: John D. Fergason, Redwood City, CA (US)

Correspondence Address: Warren A. Sklar, Renner, Otto, Boisselle, & Sklar, L.L.P., 1621 Euclid Avenue, 19th Floor, Cleveland, OH, 44115, US

(21) Appl. No.: 09/776,408

(22) Filed: Feb. 2, 2001

Related U.S. Application Data
(60) Provisional application No. 60/179,887, filed on Feb. 2, 2000.

(51) Int. Cl. G02B 27/22; G02B 27/26; G02F 1/1335; G02C 7/12

(52) U.S. Cl. 359/466; 359/465; 349/11; 349/13; 349/15; 351/49

(57) ABSTRACT

Stereoscopic eyewear (10) enables a viewer to see a three dimensional image from a two dimensional image which is projected or displayed on a screen. The eyewear may be coordinated with the two dimensional image either with a signal transmitted through a cable (40) or with an infrared (IR) transmitter (200, 201) and receiver. The IR transmitter may include two sources of IR light to increase the likelihood of reception by the transmitter. The IR transmitter may have a curved bottom (202) covered with Velcro™ material (203) for attachment to another piece of Velcro™. The curved bottom in combination with the Velcro™ enables control of the orientation of the IR transmitter. When the eyewear is connected via a cable, guide bars (61, 62) or a cable loop (42, 43, 44) can be included to provide strain relieve. The shutter or lens of the eyewear may be made from a liquid crystal cell (11L, 11R). For example, a five sided twisted nematic cell having five sides oriented at 10° cooperating a swept back frame to provide a modern streamline look fore the eyewear.

### TECHNICAL FIELD

The invention relates generally to modular 3-D shutter glasses and to methods of making and using them and associated parts thereof.

### BACKGROUND

An individual uses both eyes to see objects or images. Each eye views the world from a slightly different vantage point due to the separation of the eyes. The human brain combines the two views to allow a person to perceive depth or three dimensions (hereinafter sometimes referred to as stereo or 3-D).

Computer displays, televisions, electronic game displays, movie screens and the like are two dimensional (hereinafter sometimes referred as 2-D or planar) and lack depth. When an individual views a computer or game display, television, a movie screen or the like, both of the individual's eyes see substantially the same 2-D image. Thus, there is no perceived depth and the individual does not perceive three dimensions in the image being viewed.

The art of presenting different images to the left and right eyes of a viewer so a 3-D image (sometimes referred to as stereoscopic or stereo image) is perceived is well developed. Different images can be presented to each eye of a viewer using special eye glasses which select or distinguish between respective left and right eye images or views. One early system utilized polarized glasses where the respective lenses pass vertically polarized light to one eye and horizontally polarized light to the other eye. When a viewer is wearing such glasses and correctly polarized images are displayed on a display or projected onto a screen, etc., the viewer perceives (e.g., sees) a 3-D image. Other types of eye glasses that provide a 3-D image to the viewer have selected between right and left images by using color filter techniques, right and left circular polarizers to distinguish between right and left circularly polarized light or other means to effect desired selection.

Other known selection systems utilize eye glasses or goggles which have lenses that can be electronically opened and closed, for example, as light shutters. As the respective left and right lenses (light shutters) are alternatively opened and closed and appropriate left eye and right eye images are alternatively projected onto a screen or shown in a display in time sequence synchronized with the opening and closing of the lenses, 3-D images can be seen (perceived) by the viewer. For convenience, devices to distinguish or to select between left and right eye images for viewing may be referred to below collectively and/or equivalently as eye glasses, shutters, shutter glasses, eyewear and the like.

There are several types of display systems and modes of display operation that utilize such shutter glasses to provide left and right eye images for 3-D viewing. Examples are, as follows:

a. A first system uses an above and below format in which all of the left eye display image or information is found in either the top or bottom half of each frame or field of an image file (in some display techniques a frame of an image is composed of two sequentially displayed fields), and the right eye image or information is found in the other half of the image file. The left and right eye images derived from image data in the image file are displayed sequentially. Each image usually is expanded so it appears as a full screen image by any one of various known image expanding techniques. A similar system has the left and right eye image information displayed, respectively, on the left and right halves of the display and appropriate image expanding techniques may be used to fill the respective images on the screen for viewing by a respective right or left eye as each image is sequentially shown.

b. A second system displays images using what is generally referred to as an “interleaved system”. Interleaved systems image files contain data for one eye image in the odd numbered lines of each field of a two field frame, and data for the other eye image in the even numbered lines of that field. (If the frame only has one field, for example, then the odd and even numbered lines of the frames would be used, etc.) A first image is displayed using the data from the odd numbered lines of each field of the image and then a second image is displayed using the data from the even numbered lines. As the images are shown on the display, one shutter, e.g., the left eye shutter of the eye glasses, is opened for one image and closed for the second image while the other shutter, e.g., the right eye shutter of the eye glasses, is opened for the second image and closed for the first image.

c. A third system displays images in what is sometimes called “page flip” mode. In a page flip system, the image file is organized so that one field of a frame contains left eye image data and the other field contains right eye image data. Left and right eye images are alternatively shown on the display as respective fields of frames of data are provided from the image file.

Various techniques are used to store image information as data in files, such as digital files, sometimes referred to as graphic files or image files. Several standard techniques and graphic file formats resulting therefrom lead to graphic files known as JPEG (sometimes referred to as JPG), GIF, BMP, TIF, and others; such files usually have a “dot suffix” in their name identification, such as, .JPG, GIF, .BMP, .TIF, etc. Other standard techniques and formats include Apple Quicktime movies and RealNetworks RealPlayer movies. These standard techniques and formats are exemplary. There are others now in existence with more likely to be developed in the future.

A graphics file for displaying 3-D images contains image information for both the left eye and right eye images or views or, in the computational system mentioned above, the image information for one eye view and information concerning the computational algorithm to prepare the other eye view.

Images can be displayed on a computer monitor, television, or other display or can be projected. Usually specialized hardware and software are needed to display or project 3-D images and to coordinate and synchronize the eye glasses with the respective right and left images being displayed. Prior systems required substantial circuitry, control systems, control boxes, power supplies and the like to provide power to the shutter eye glasses and to provide the coordination and synchronization. Accordingly, there is a need in the art to reduce the size, to improve the efficiency and to reduce costs of such systems.

Prior 3-D viewing systems usually were specially designed to work in a single environment, e.g., a computer and monitor/display environment, a television display environment or with a special display system, such as a video game or other 3-D viewing system. Upon changing to a different display system, whether an upgrade or that of a different vendor, typically it was necessary in the past also to acquire a new shutter glasses system and controller for power, coordination and synchronization therefor. Also, some prior shutter glasses systems and controllers were designed for specific use with a computer monitor or for specific use with a television. Accordingly, there is a need in the art for improved versatility for such shutter eye eyewear system and controllers therefor.

### SUMMARY OF THE INVENTION

Briefly, according to an aspect of the invention, a stereoscopic eyewear system including eyewear for generating a three dimension image from a viewed two dimensional image using a reference signal, and at least two transmission sources for generating the reference signal, wherein the reference signal coordinates the eyewear to the two dimensional image, and wherein each of the at least two transmission sources transmits to an area not covered by another of the at least two transmission sources.

Briefly, according to an aspect of the invention, a stereoscopic eyewear system including eyewear for generating a three dimension image from a viewed two dimensional image using a reference signal, the eyewear including two shutters each having electrical connections, a transmission line for conducting the reference signal to two shutters of the eyewear, and at least one strain relief feature for relieving strain applied via the transmission line.

According to an aspect of the invention a head mountable frame for light shutters for viewing of images includes a retainer mechanism to retain a light shutter mechanism, a cavity in the frame for a circuit to provide for operation of a light shutter, and a closure for the cavity to retain a circuit.

According to another aspect, a viewing apparatus for viewing stereoscopic images includes a mounting frame for wearing on the head of a person, a pair of light shutters in the mounting frame, circuitry to provide signals to the light shutters for operating the shutters, a cavity in the mounting frame for at least part of the circuitry, and a closure for the cavity to retain the circuitry.

According to another aspect, a viewing apparatus for viewing stereoscopic images includes a mounting frame for wearing on the head of a person, a pair of light shutters in the mounting frame, circuitry to provide signals to the light shutters for operating the shutters, and wherein the mounting frame has a non-planar, wrap-around shape.

According to another aspect, a viewing apparatus for viewing stereoscopic images includes a mounting frame for wearing on the head of a person, a pair of light shutters in the mounting frame, circuitry to provide signals to the light shutters for operating the shutters, and further comprising a strain relief to retain with respect to the frame wiring to provide for operation of light shutters, the strain relief including at least two openings for threading of wiring therethrough to provide for relatively sharp bends in the wiring to resist pulling of the wiring through the openings while transmitting pull force directly to the frame.

According to another aspect, a viewing apparatus for viewing stereoscopic images includes a mounting frame for wearing on the head of a person, a pair of light shutters in the mounting frame, circuitry to provide signals to the light shutters for operating the shutters, and further comprising a strain relief to retain with respect to the frame wiring to provide for operation of light shutters, wherein the strain relief comprises a number of bar-like protrusions on the frame for passing wiring therebetween.

According to another aspect, a viewing apparatus for viewing stereoscopic images includes a mounting frame for wearing on the head of a person, a pair of light shutters in the mounting frame, circuitry to provide signals to the light shutters for operating the shutters, and wherein the mounting frame includes temple pieces, the circuitry comprising wiring connection to an external electrical source, and a clip slidable on a temple piece for clipping wiring with respect to the temple piece to hold the wiring in generally parallel relation with at least a portion of the temple piece and to determine the location along the temple piece where the wiring is released from substantially parallel relation.

According to another aspect, a transmitter housing for a device for transmitting electromagnetic energy to a receiver includes a transmitter having a housing for an electromagnetic energy transmitter, the housing having a curved wall for supporting the housing, a variable retainer at the curved wall for cooperation with a support surface to position the housing at various directional angles relative to such support surface.

According to another aspect, a stereoscopic eyewear system includes eyewear for generating a three dimension image from a viewed two dimensional image using a reference signal; and at least two transmission sources for generating the reference signal, wherein the reference signal coordinates the eyewear to the two dimensional image, and wherein each of the at least two transmission sources transmits to an area not covered by another of the at least two transmission sources.

According to another aspect, a stereoscopic eyewear system includes eyewear for generating a three dimension image from a viewed two dimensional image using a reference signal, the eyewear including two shutters each having electrical connections; a transmission line for conducting the reference signal to two shutters of the eyewear; and at least one strain relief feature for relieving strain applied via the transmission line.

A number of features are described herein with respect to embodiments of the invention; it will be appreciated that features described with respect to a given embodiment also may be employed in connection with other embodiments.

To the accomplishment of the foregoing and related ends, the present invention, then, comprises the features hereinafter fully described and/or particularly pointed out in the claims. The following description and the annexed drawings set forth in detail certain illustrative embodiments of the present invention. These embodiments are indicative, however, of but a few of the various ways in which the principles of the present invention may be employed.

Although the present invention is shown and described with respect to certain preferred embodiments, it is obvious that equivalents and modifications will occur to others skilled in the art upon the reading and understanding of the specification. The present invention includes all such equivalents and modifications, and is limited only by the scope of the claims.

### BRIEF DESCRIPTION OF THE DRAWINGS

FIG. 1 is a top view of liquid shutter glasses in accordance with an embodiment of the present invention.

FIG. 2 is a perspective view of the shutter glasses of FIG. 1;

FIG. 3 is a back inside view of the shutter glasses of FIG. 1;

FIG. 4 is a fragmentary isometric view of a mounting tab for attaching a lens holder and frame of the shutter glasses of FIG. 1;

FIG. 5 is a side view of the shutter glasses of FIG. 1;

FIG. 6 is a front view of the shutter glasses of FIG. 1;

FIG. 7 is a fragmentary view of a strain relief of FIG. 1;

FIG. 8 is an exploded isometric view of the lens holder of the shutter glasses of FIG. 1;

FIG. 9 is a back inside view of the assembled lens holder of FIG. 8;

FIG. 10 is a fragmentary view of a connection between a cable and the shutter terminals;

FIG. 11 is a back inside view of the lens holder for the shutter glasses of FIG. 1 showing the tape wire retainer in position;

FIG. 12 is an enlarged fragmentary view of the mounting opening for the lens holder;

FIG. 13 is back view of a wire retainer used in the lens holder;

FIG. 14 is back and front views of a wire retainer used in the lens holder;

FIGS. 15, 16, 17, 18, 19, 20, 21, 22, 23 and 24 are, respectively, front isometric, back isometric, top, front, back inside, bottom, left, right, left inside, and right inside views of another embodiment of lens holder;

FIGS. 25, 26, 27, 28, 29, 30, 31, 32, 33 and 34 are, respectively, front isometric, back isometric, top, front, left, right, back inside, bottom, left and right views, respectively, of another embodiment of lens holder;

FIGS. 35, 36, 37, 38, 39, 40, 41 and 42 are, respectively, front isometric, back isometric, top, front, right side, left side, bottom, back inside, bottom, views of another embodiment of lens holder;

FIGS. 43, 44, 45, 46, 47, 48, 49 and 50 are, respectively, exploded isometric back inside, back inside with wire retainer tape, top, front, front isometric in frame, back inside in frame, left side, views of the lens holder of FIGS. 35-42 sometimes including a frame;

FIG. 51 is a front view of a liquid crystal shutter assembly for the embodiment of lens holder of FIGS. 32-50;

FIG. 51a is an expanded view of a sealed injection point of FIG. 51;

FIG. 52 is a side view of a liquid crystal shutter assembly for the embodiment of lens holder of FIGS. 32-50;

FIG. 53 is an expanded view of the liquid crystal cell of the liquid crystal shutter assembly for the embodiment of lens holder of FIGS. 32-50;

FIG. 54 is an expanded view of the liquid crystal cell in combination with the polarizers of a liquid crystal shutter assembly for the embodiment of lens holder of FIGS. 32-50;

FIGS. 55, 56, 57, 58, 59 and 60 are, respectively, front isometric, top, front, bottom, left and right views of a transmitter;

FIGS. 61 and 62 are top and side views of another transmitter similar to that mentioned above;

FIGS. 63 and 63a are another cable assembly;

FIGS. 64, 65, 66, 67 and 67a are views of another transmitter similar to that mentioned above.

### DETAILED DESCRIPTION OF THE INVENTION

Referring in detail to the drawings, wherein like reference numerals designate like parts in the several figures, and initially to FIGS. 1, 2 and 3, a pair of modular shutter glasses 10 is illustrated. The modular shutter glasses 10 may be used, for example, to view left eye and right eye images that are projected or shown on a display to allow the user to see or to perceive 3-D stereo images. The modular shutter glasses 10 include two shutters 11L and 11R that are selectively operated to transmit light or to block light transmission from reaching respective left and right eyes of a user. Synchronizing operation of the shutters 11L, 11R with the left and right eye images shown on a display allows the respective images to be seen or to be blocked from respective eyes of the user so that the user sequentially sees left and right eye images and perceives a 3-D stereo view. The shutters 11L, 11R may be various types of shutters including twisted nematic liquid crystal cells combined with respective light polarizers to work as shutters blocking or transmitting light in response to application of suitable electric field or other energization, for example. The shutters 11L, 11R may be other types of devices which can function in a controlled manner selectively to transmit light or to block light transmission. The shutters 11L, 11R sometimes are referred to below as shutters, liquid crystal shutters, light shutters, lenses, and the like. The term lenses sometimes being used because the shutters 11L, 11R are analogous to lenses used in a conventional eye glass frame in that they affect light intended for viewing (or being blocked from view) by the eye(s) of a user. Other types of shutters may be used in the present invention.

The modular shutter glasses 10 include a lens holder 12 and a frame 13. The lens holder 12 includes openings 14L, 14R in the area in which the respective shutters 11R, 11L may be positioned to control transmission of light through the openings 14L, 14R to the respective eyes of a user.

An attaching mechanism 15 provides an attachment for the lens holder 12 and frame 13. The attaching mechanism 15 includes a mounting opening 16 in the lens holder 12 and mounting tabs 17 in the frame 13. Respective mounting tabs 17 fit in respective mounting openings 16 to attach the lens holder 12 and frame 13.

The frame 13 has a pair of temple pieces 20, 21 attached to a front cross support or cross bar 22. The temple pieces 20, 21 are similar to the temple pieces used in conventional eye glass frames. The front cross support 22 provides fixed relative positioning of the temple pieces 20, 21 with respect to each other and with respect to the front cross support 22. Extensions 20a, 21a of the front cross support 22 are attached to the respective temple pieces 20, 21. The temple pieces 20, 21 may be a single piece which does not allow for relative movement or, if desired, there may be a hinged connection between the two, for example, at the area 20b, 21b to allow for the temple pieces 20, 21 to fold together in the manner similar to the way temple pieces 20, 21 typically fold on conventional eye glass frames for storage purposes, for example.

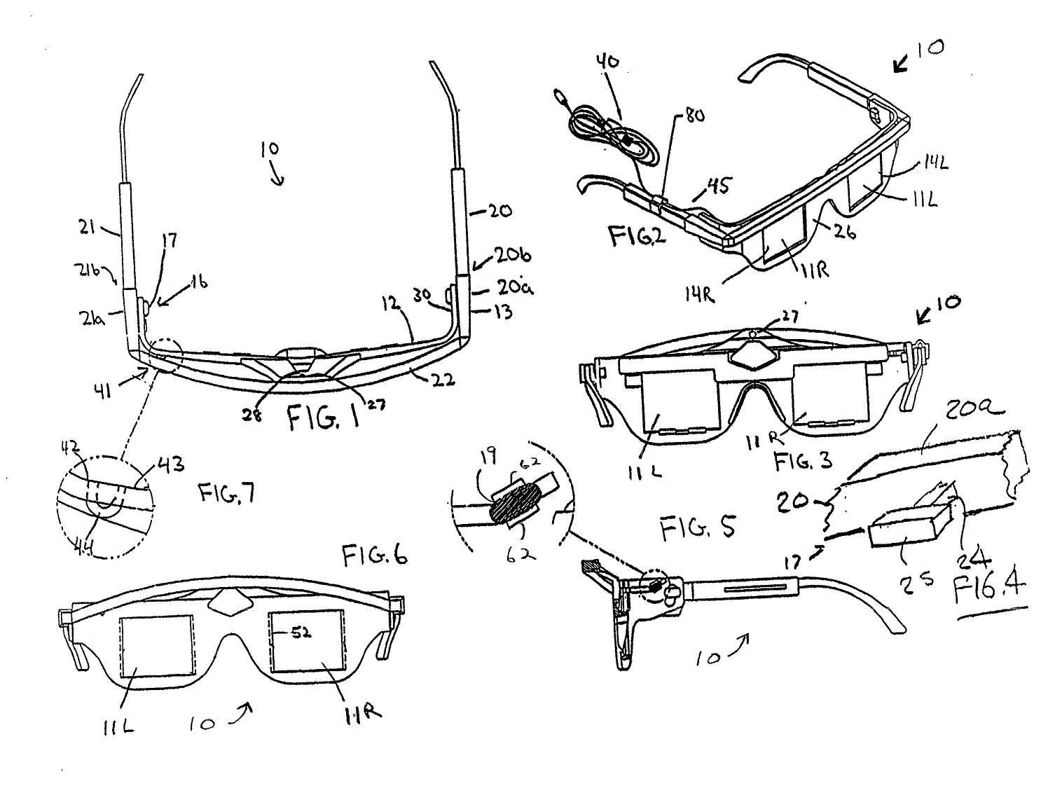

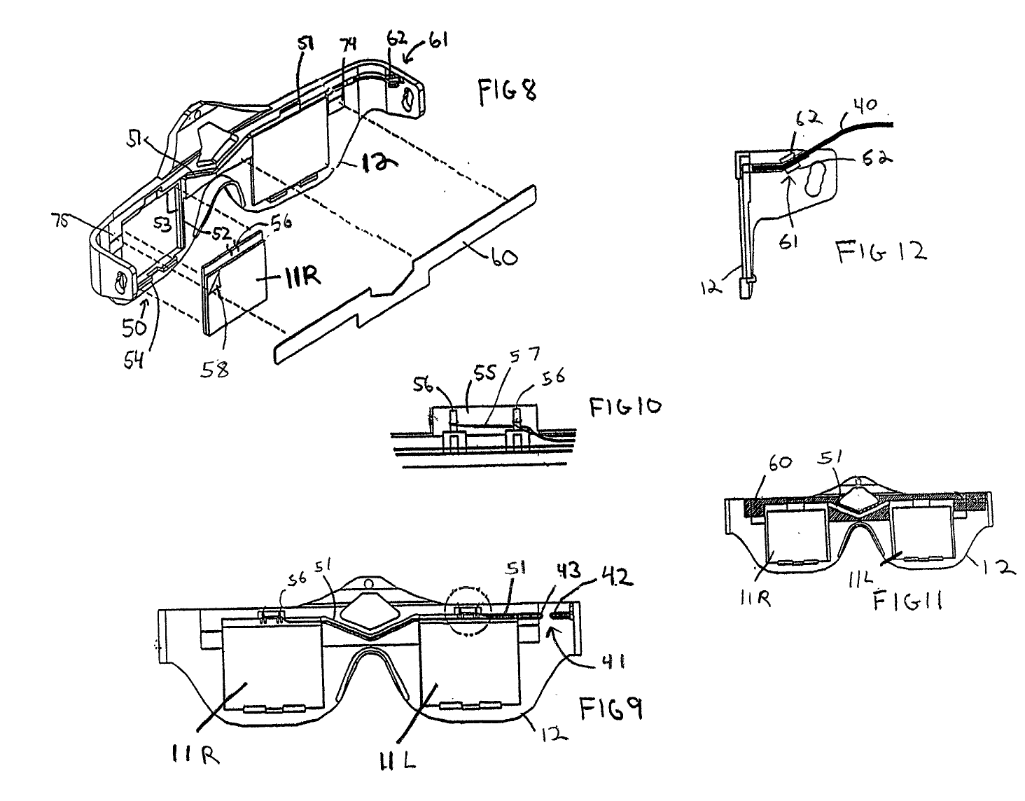

The lens holder 12 may be installed on the frame 13 by orienting the mounting openings 16 in alignment with the mounting tabs 17. As is illustrated schematically on a relatively larger scale in FIG. 4, the mounting tabs 17 have a relatively narrow cross sectional area shaft 24 that is molded directly as part of the extension 20a of the frame 13, and also have a relatively larger cross sectional area, somewhat bulbous portion 25 at the end of that shaft 24. The mounting opening 16 in the lens holder 12 includes an elongate or slot-like area able to fit over the bulbous portion 25 of the mounting tab 17. The mounting opening 16 not only is slot-like but also the elongate axis of the slot is at an angle as illustrated in FIG. 5. The angle is measured from an axis which is generally parallel to the elongate extent of the temple piece 20, for example. The elongate extent of the bulbous portion 25 of the mounting tab 17 generally is parallel to such elongate axis of the temple portion. The lens holder 12 ordinarily is positioned in the frame 13 so that the somewhat planar front face 26 thereof is generally perpendicular to the elongate extend of the temple pieces 20, 21. An opening 27 (FIGS. 1 and 3) at the top of the front face 26 of the lens holder 12 is provided to cooperate with a tab or stud 28 of the frame 13.

To assemble the lens holder 12 and frame 13, the mounting openings 16 are aligned relative to the mounting tabs 17 at an appropriate angle so that the bulbous portions 25 of the mounting tabs 17 will fit in the slot-like extent of the respective mounting openings 16. The lens holder 12 has sides 30 in which the mounting openings 16 are located. Those sides extend generally perpendicularly relative to the front face 26 of the lens holder 12 and may resiliently press against the extensions 20a, 21a of the frame 13 when installed in an orientation shown similar to that of FIGS. 1-3. The lens holder 12 is positioned relative to the frame 13 to place the sides 30 adjacent the mounting tabs 17 with the elongate direction of the mounting openings 16 being generally parallel to the linear extent of the bulbous portion 25. The bulbous portion 25 is inserted through the mounting openings 16. The lens holder 12 then is rotated about the shafts 24 of the mounting tabs 17 to orient the lens holder 12 in the relation to frame 13 as is illustrated, for example, in FIGS. 1-3 and 5. In such orientation the bulbous portion 25 cannot pass through the mounting opening 16 and, therefore, retains the lens holder 12 to the frame 13. Additionally, the tab 28 on the frame 13 fits in the opening 27 in the front face of the lens holder 12 and prevents further rotation of the lens holder 12 relative to the frame 13.

The frame 13 is manufactured and sold under the trademark UVE™ and is available for use with various sunglasses.

Using a somewhat standard frame 13, various lens holders 12 having different stylish and/or functional configurations may be mounted in the frame, thus providing a modular structure. In the past shutter glasses for 3-D viewing were relatively heavy, complex, difficult to make, and non-stylish. Using features of the present invention, the frame is relatively light weight, the attaching means is relatively uncomplex and secure and the lens holder 12 is relatively light weight, stylish, and easily changed to provide for changes in style. For example, a retailer may stock several different lens holder 12 styles and a single style of frame. A purchaser may select any of the lens holder 12 styles and attach them to a frame for use.

Referring to FIG. 2, an electrical cable 40 is connected to the liquid crystal shutters 11L, 11R and associated circuitry (not shown in FIG. 2) for driving the liquid crystal shutters 11L, 11R to respective operational modes, e.g., light blocking and light transmitting modes. A strain relief 41 shown in FIGS. 1 and 7 is provided for the cable 40. It is noted here that the strain relief can be used in other embodiments hereof and that various features shown in a given embodiment also may be used in other embodiments. The strain relief 41 prevents a pull force applied to the cable 40 from breaking connections of cable conductors 57 and the circuit and/or shutters 11L, 11R (or terminals thereof) in the lens holder 12. The strain relief 41 includes a pair of openings 42, 43 (or more openings, if desired) in the lens holder 12. The cable 40 may be threaded through and looped through those openings and pulled relatively taught to form a loop 44 of the cable 40, as is seen in both FIGS. 1 and 7. If desired, a dab of glue 19 may be applied to the cable loop 44 and openings 42, 43 for further securement of the strain relief. The relatively sharp bend of the cable loop 44 and frictional relation of the cable 40 relative to the lens holder 12 at the openings 42, 43 provides the strain relief function. Therefore, a tug on the cable 40 at the extent 45 thereof beyond the strain relief 41 will not be transmitted through the strain relief to the connections of the cable 40 to the circuit and/or shutters 11L, 11R.

Turning to FIGS. 3, 6, 8, 9 and 11, the shutter retainer 50 for retaining the shutters 11L, 11R in the lens holder 12, and the cable way (or wire way) 51 in the lens holder 12 via which the cable 40 passes for connection to the respective shutters 11L, 11R are illustrated. The openings 14L, 14R in the lens holder 12 are formed to have a stepped ledge 52 at the respective sides and top thereof. The lenses may be inserted into the openings 14L, 14R and be stopped from passing through the openings 14L, 14R by engagement with the walls 53 at the respective ledges. At the bottom of each opening 14L, 14R are one or more retainer tabs 54. Each retainer tab 54 includes a generally horizontal wall surface and an upstanding flange, as can be seen in FIG. 9 and in other figures. The tabs 54 are resilient and cooperate with the ledges 52 to retain the shutters 11L, 11R in the openings. For example, the shutters 11L, 11R are aligned with and inserted in the openings and positioned against the ledge walls 53 and side walls of the ledges. The tabs 54 may be resiliently deformed to allow the bottom edge of a given shutter to pass over the tab flange and into the recessed area of the tab 54. The tab 54 then springs back to retain the shutter in the respective opening. At the top of each liquid crystal shutter 11L, 11R are two or more shutter contacts 56 (also know as terminals, electrodes, contacts, and the like) to which connection can be made to respective conductors of the cable 40. The cable 40 may be placed in the cable way 51 so that respective conductors thereof are exposed at the recesses or chambers 55 communicating between the cable way 51 and the shutter contacts 56 so the respective cable conductors 57 can be soldered or otherwise attached to the respective shutter contacts 56. The front and back of the liquid crystal shutters 11L, 11R may optionally include a protective release 58.

An enlarged view of a chamber 55 in which the shutter contacts 56 are seen connected to respective cable conductors 57 is illustrated in FIG. 10. The connection of the shutter contacts 56 and conductors may be by wrapping the conductors about the shutter contacts 56. Additionally solder may be applied to the shutter contacts 56 to assure secure connection.

A tape 60 may be applied over at least part of the cable way 51 and a top part of the shutters 11L, 11R. The tape has adhesive on a surface thereof to retain the tape to a surface of the lens holder 12 and possibly also to a surface of respective shutters 11L, 11R. The tape 60 helps to retain the shutters 11L, 11R in the lens holder 12 and also covers the cable way 51 and the chambers 55 to protect the connections between the contacts 56 and conductors 57. The openings 42, 43 of the strain relief 41 are seen in FIG. 9.

An additional strain relief 61 also may be provided. Such additional strain relief includes several guide bars 62 between which the cable 40 may be positioned as the cable 40 exits the cable way 51. A small amount of glue 19 or adhesive, for example, ultraviolet (UV) curable adhesive may be placed in the area 61 to secure the cable 40 and lens holder 12 together to prevent force applied to the cable 40 at a connector end 40c thereof from pulling the cable 40 from the cable way 51 and/or breaking the connections with the contacts 56.

The completed lens assembly 12a may be mounted in a frame 13 for use to control transmission of light to the eyes of the user. The transmission control is effected in response to the electrical input provided to the shutters 11L, 11R via the cable 40. The connector end 40c of the cable 40 may be connected to a computer or to some other source of electrical signals to operate the shutters 11L, 11R accordingly.

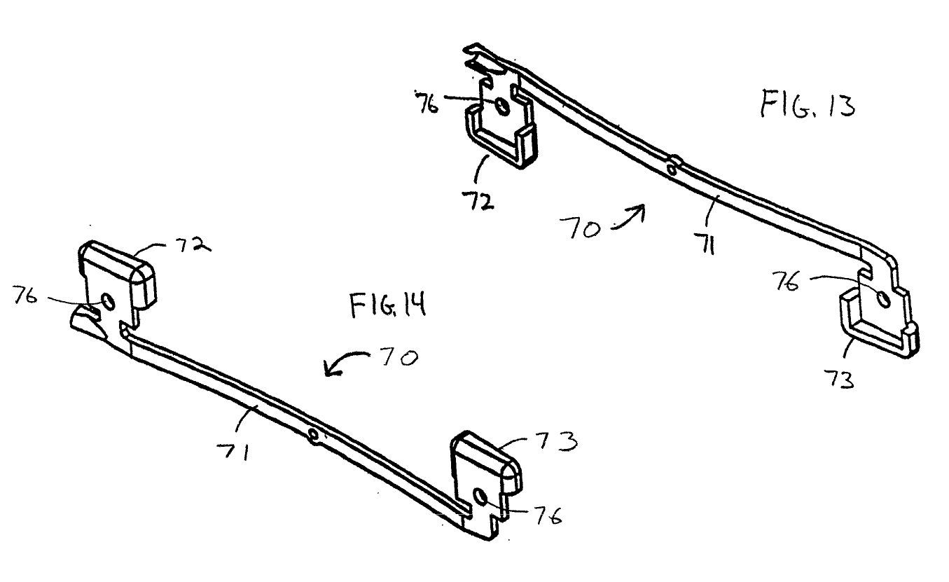

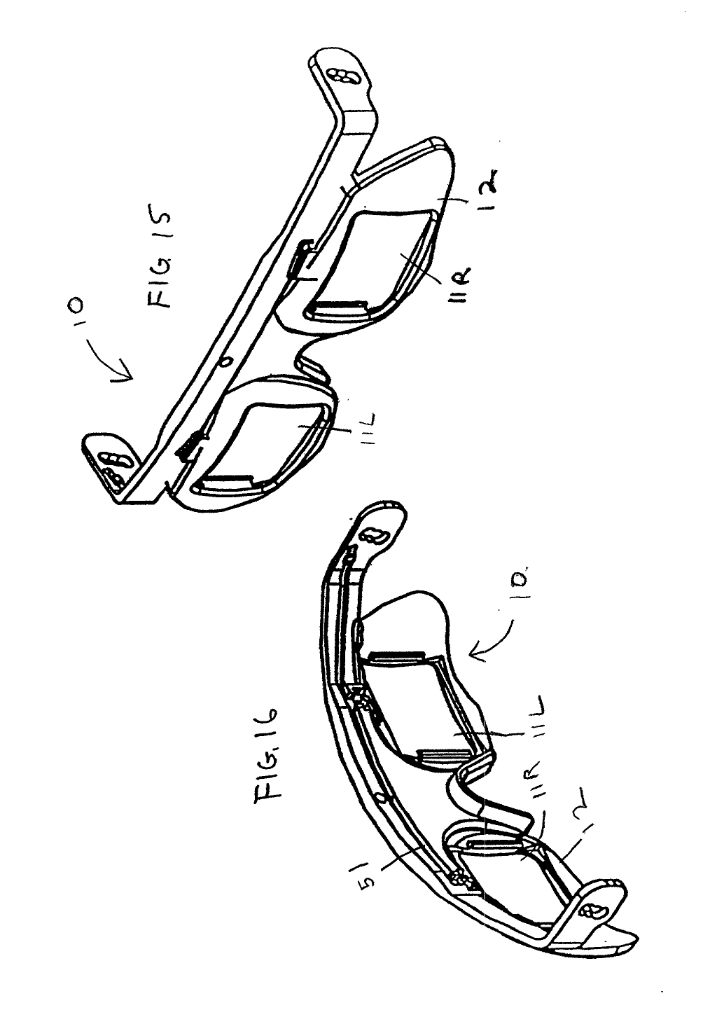

FIGS. 13 and 14 show a wire retainer 70. The wire retainer 70 may be used to cover the cable way 51 in the lens holder 12 in place of the tape 60. The wire retainer 70 includes an elongate rib support 71 with end caps 72, 73. The elongate rib support 71 is of a length and shape to cover the entire cable way 51 where that cable way 51 extends between a pair of surfaces or lands 74, 75 (FIG. 8). The wire retainer 70 may be molded plastic having suitable flexibility to fit and hold in place as described. The end caps 72, 73 substantially fully enclose the lands 74,75 while the elongate rib support 71 extends over and possibly partway into the cable way 51, thus protecting the cable 40 in the cable way 51 and also covering the chambers 55.

Openings 76 in the end caps 72, 73 may be provided to facilitate positioning and retention of the wire retainer 70 on posts (not shown) on the lands 74, 75; even if such posts are not used, glue may be inserted into the openings 76 to secure the wire retainer to the lands.

Briefly referring back to FIG. 2, a clip 80 is positioned on the temple piece 21. The clip 80 may be slidable along the temple piece or it may be positioned thereon and securely retained in position by snap fit, for example, staying in a single location tending not to slide along the temple piece. The clip 80 has a small passage 81 through which the cable 40 may pass with out distorting the cable 40, on the one hand, and while retaining the cable 40 relative to the temple piece and clip 80. The clip 80 may be located at various places along the length of the temple piece 21 to determine the place on the temple piece where the cable 40 leaves the modular shutter glasses for connection to a computer, television or other circuitry. By positioning the clip 80 at a location along the length of the temple piece 21, the place where the cable 40 comes off the temple piece may be adjusted for the comfort of the user and to avoid interfering with earrings, a hat, and the like.

A method of making the modular shutter glasses 10 includes molding or otherwise forming the lens holder 12 of a suitable material. An exemplary material may be polycarbonate which has suitable flexibility and strength. Place the liquid shutters 11L, 11R in the respective openings 14L, 14R. Secure connections between the cable conductors 57 and the liquid crystal shutter terminals 56; and provide a wrapped connection or soldered connection thereof. Thread the cable 40 through the openings 42, 43 to provide the strain relief 41; such forming of the strain relief can be before connecting the cable 40 to the shutters 11L, 11R. Apply glue, if desired to the strain relief 41. Feed the cable 41 through the ribs 62 of the strain relief 61 and apply glue there. Cure the glue at one or both places if needed. Apply the tape 60 or wire retainer 70 to the lens holder 12 to cover the cable way 51 to protect the cable 40 and connections and to help retain the shutters 11L, 11R in the lens holder 12. Align the mounting openings 16, with respective mounting tabs 17; bend the resilient sides 30 of the lens holder 12 toward each other to allow the mounting tabs 17 to pass into the mounting openings 16. Rotate the lens holder 12 approximately about the axes of the shafts 24 of the mounting tabs 17 and relative to the frame 13. Position the tab 28 in the opening 27 to hold the lens holder 12 in proper position relative to the frame 13 so the shutters 11L, 11R are properly positioned with respect to a user's eyes when the assembly 10 is used, for example, as is illustrated in FIG. 2. Apply the clip 80 to retain the cable 40 to the temple piece 21, and locate the clip 80 at a desired place for comfort or the like.

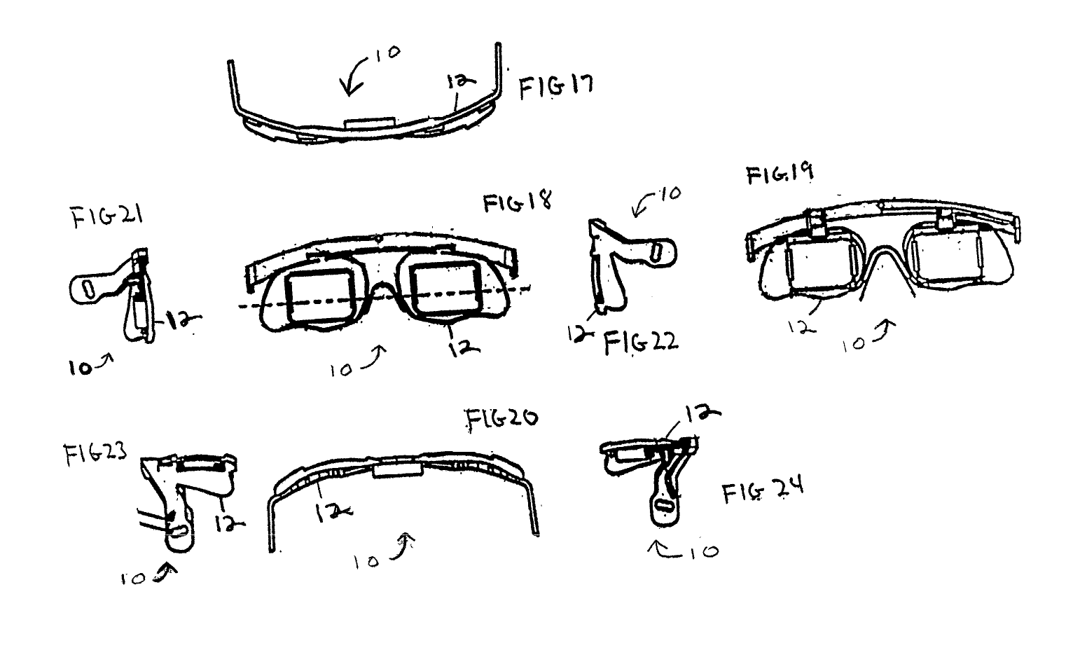

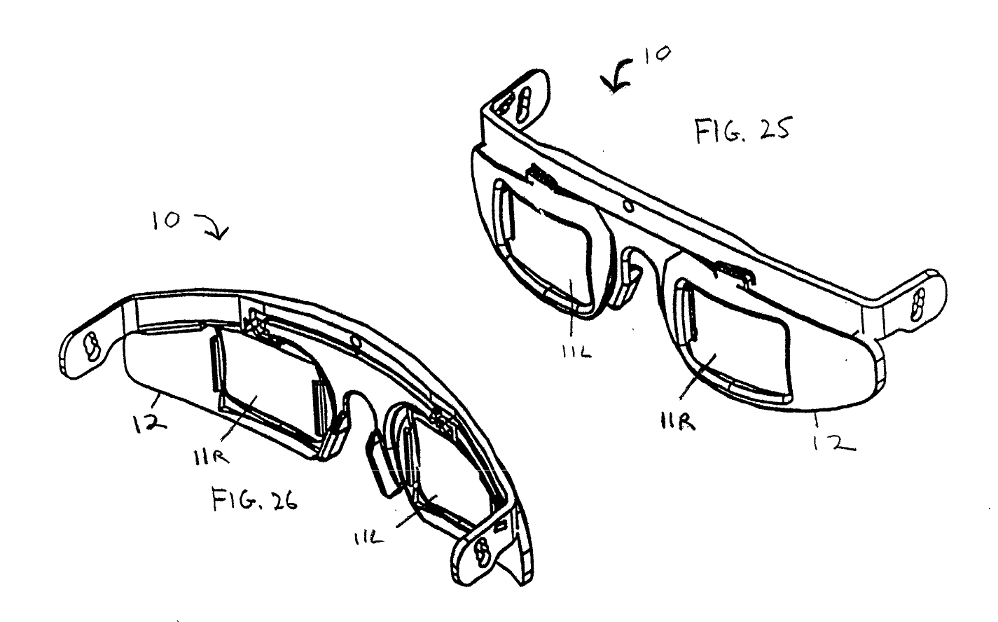

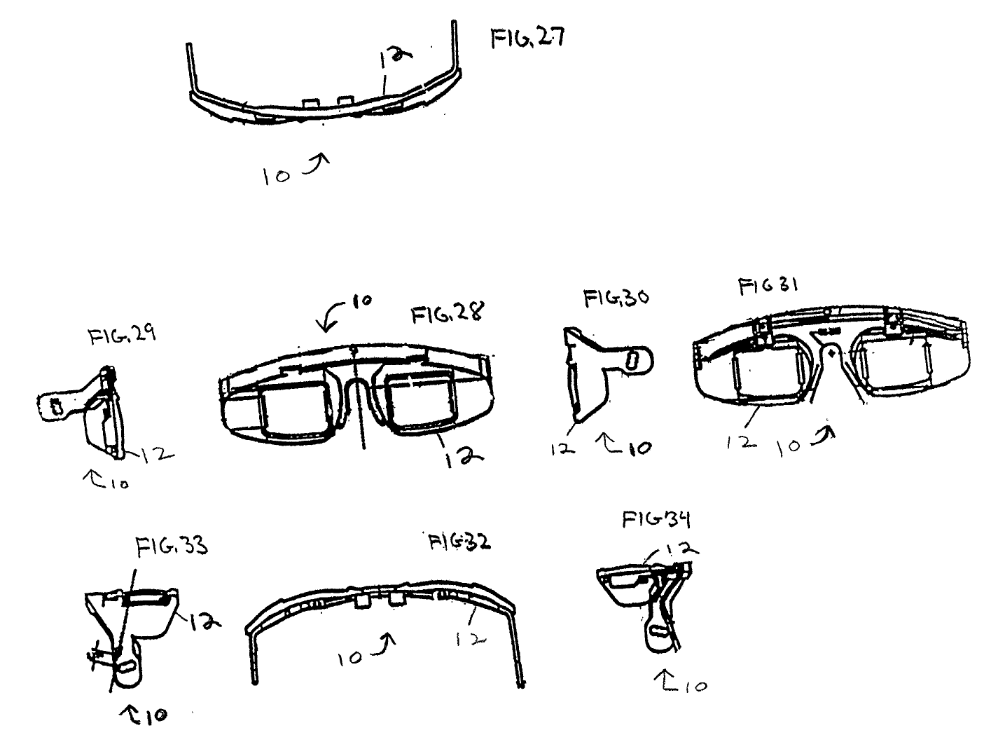

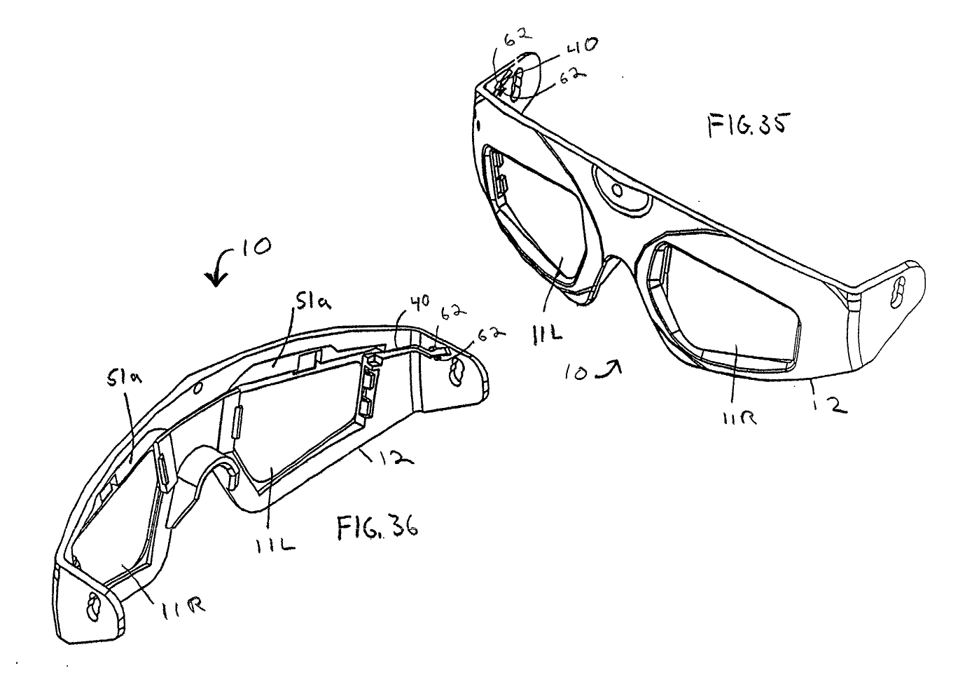

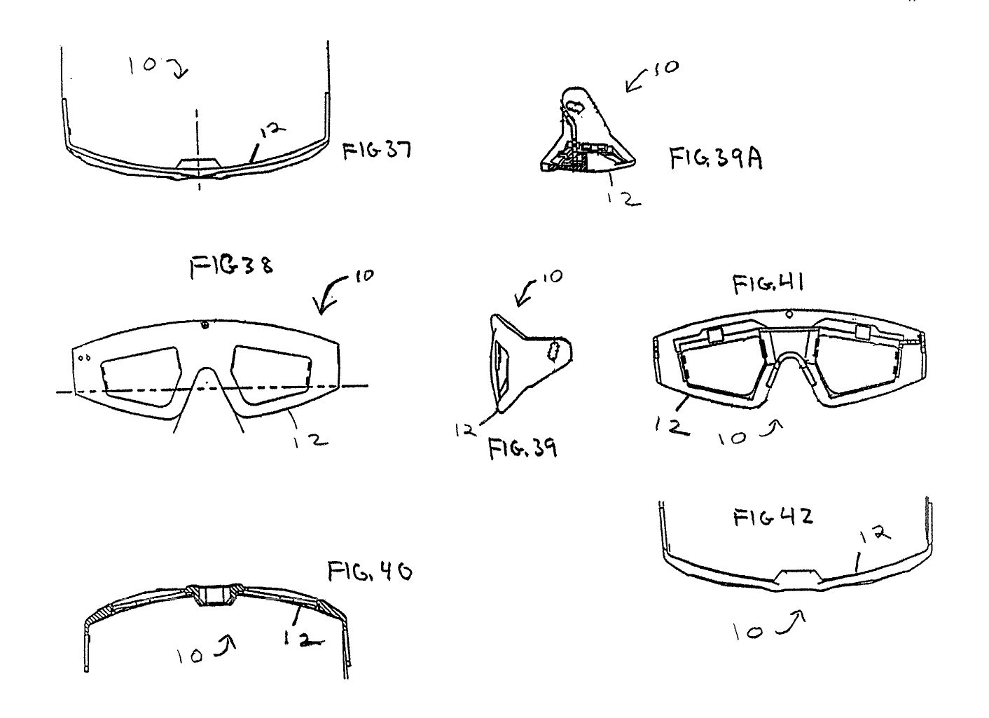

Various lens holders may be substituted for the lens holder 12 in the shutter glasses 10 in the FIGS. 1-13 described above. Examples of several embodiments of other lens holders 12 having different styles and shape are illustrated in FIGS. 15-24; in FIGS. 25-34;

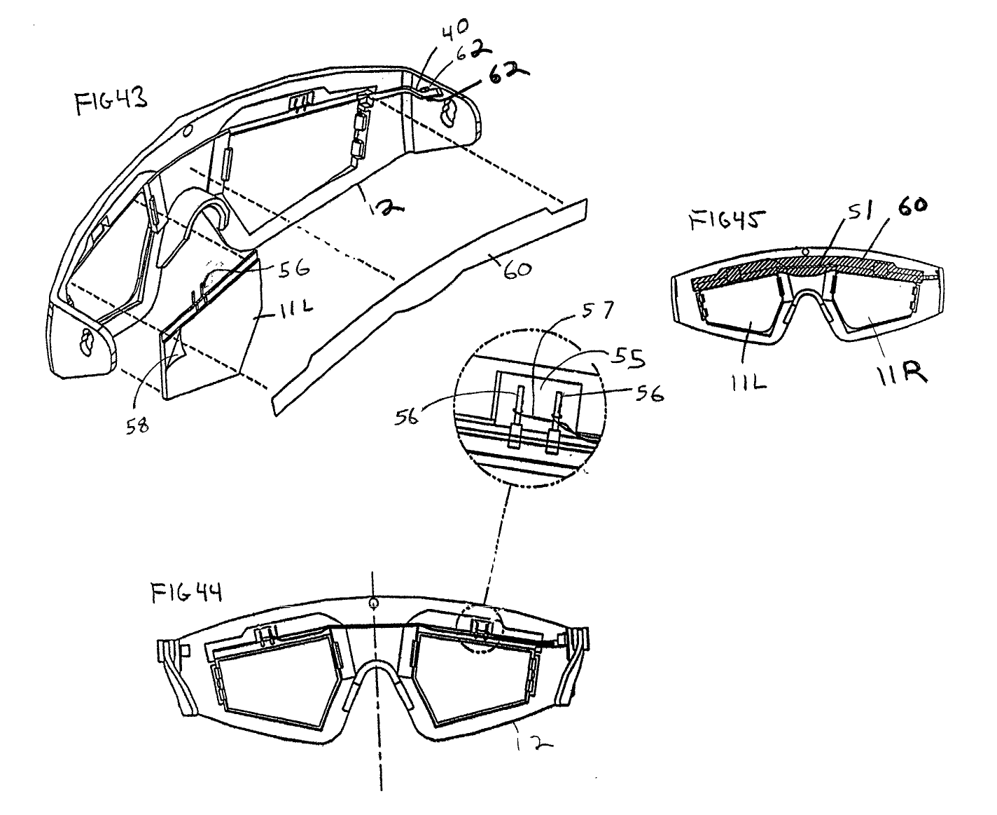

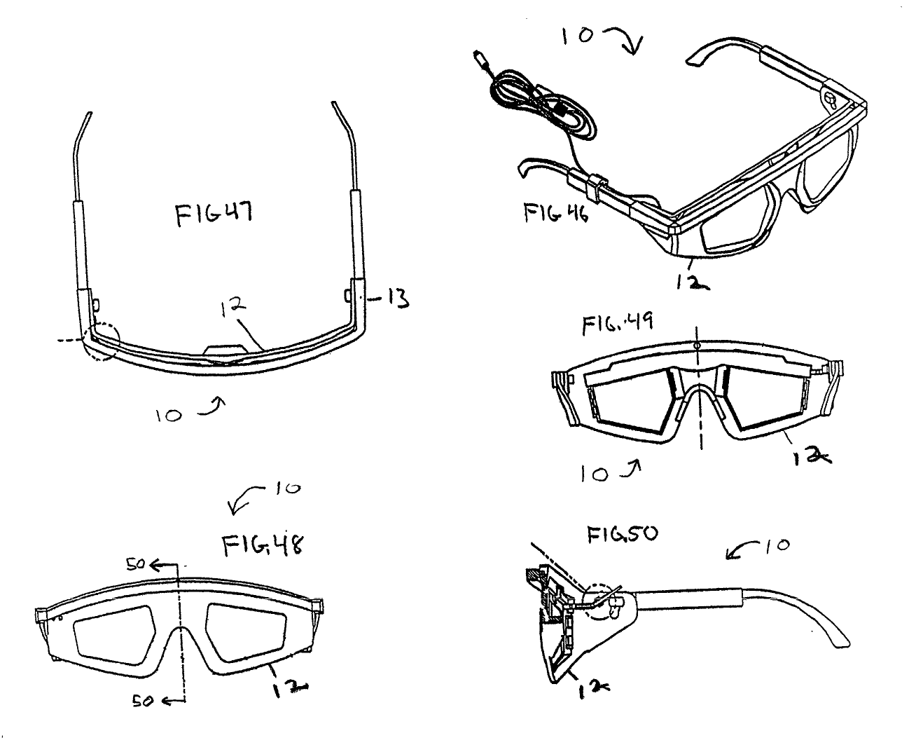

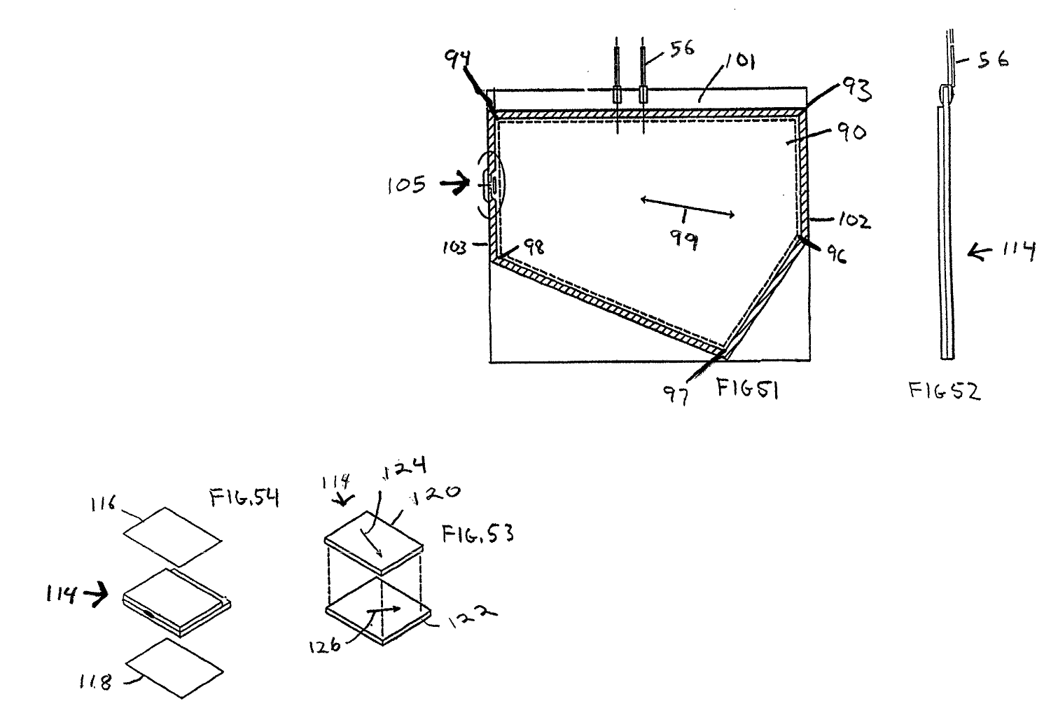

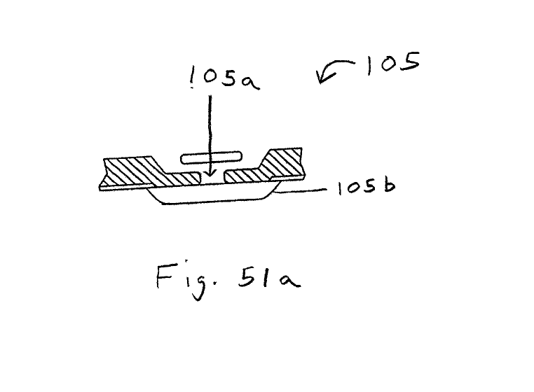

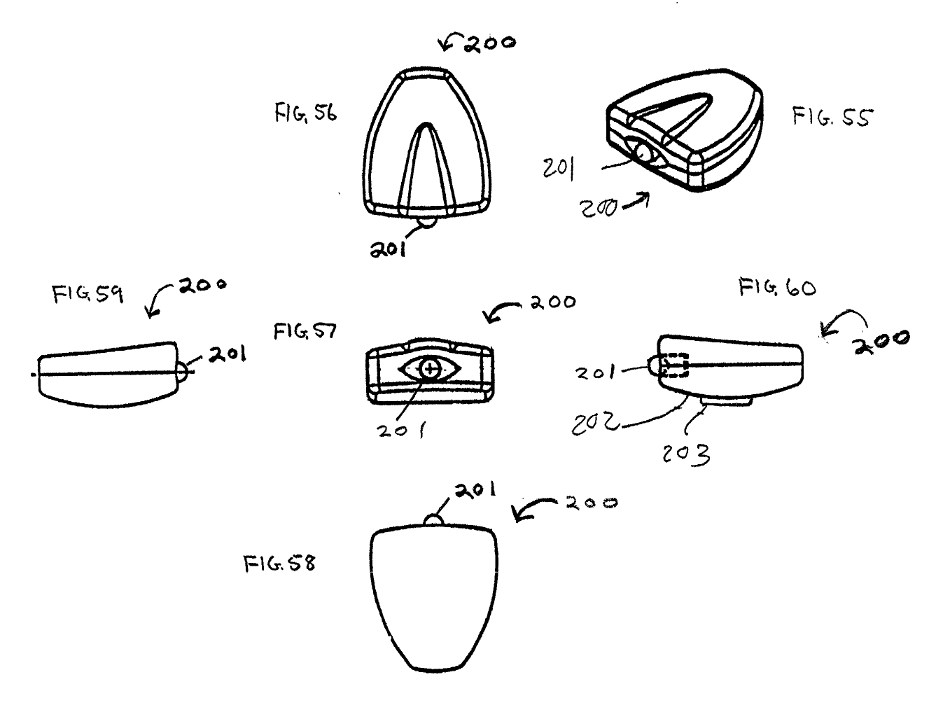

and in FIGS. 35-45. The embodiment of lens holder 12 shown in FIGS. 35-45 also is illustrated in full assembly views in FIGS. 46-50.

From the foregoing, then, it will be appreciated that the various lens holders 12 may be attached to a frame 13 to provide rather different stylish looks which were not previously attainable in previous 3-D shutter glasses.

Although the cable way 51 described above is relatively long and narrow to accommodate the cable 40, it will be appreciated that the cable way 51 may be enlarged to receive a small circuit board and, if used, a battery as a power supply for the circuit board shutters 11L, 11R. An example, of an area to receive such a small circuit board is illustrated at 51a in the embodiment of lens holder 12 shown in FIG. 36.

Referring to the embodiment of lens holder 12 illustrated in FIGS. 35-50, it is noted that the liquid crystal shutters 11L, 11R are five sided to give a very stylish look to the shutter glasses 10 used therewith. The liquid crystal shutter 90, which includes a liquid crystal cell, has two right angle corners 93, 94 which facilitate mounting of the shutters 11L, 11R (and manufacturing them) in the lens holders 12 of the shutter glasses 10. The liquid crystal shutter 90 is cut at angles other than right angles at the corners 96, 97, 98. The rub directions of the liquid crystal cells are not parallel to either of the edges 101, 102 of the liquid crystal cells; rather the rub directions are oriented perpendicular to each other, but other than parallel to the edges so that good contrast is obtained, e.g., substantially maximum dark condition with minimal light leakage occurs in the light blocking mode, while allowing the shutters 11L, 11R to be angularly oriented and somewhat swept back, whereby, for example, the top edge 101 is not substantially horizontal or parallel to the frame 13 front cross support 22; and the shutters 11L, 11R are not coplanar, the edge 102 is further forward than the edge 103, thus providing the somewhat swept back appearance provided by the swept back shape of the lens holder 12.

FIG. 51 shows a planar view of an embodiment of a five sided liquid crystal shutter 90. The liquid crystal shutter 90 has two right angle corners 93, 94 and three non-right angle vertices 96, 97, 98. The interior angles at the three vertices 96, 97, 98 can be set so as to result in stylish eyewear. The interior angles of FIG. 51 are set at 135° at vertex 96, 92.5° at vertex 97, and 112.5° at vertex 98. The liquid crystal shutter has a maximum contrast axis 99 that slopes downward from the left hand side to the right hand side at a 10° angle relative to the top edge 101. The left side edge 103 includes a sealed injection port for the liquid crystal material of the liquid crystal shutter 90. FIG. 51a shows an expanded view of the sealed injection port 105. The liquid crystal material is injected or otherwise made to flow in through the port opening 105a and is then sealed within the liquid crystal shutter 90 by a seal 105b.

An exemplary arrangement of one of the liquid crystal shutters 11L, 11R is shown as a liquid crystal cell 114 with respective adjacent upper and lower polarizers 116, 118. FIG. 53. shows an expanded view of an upper substrate 120 and a lower substrate 122 between which a liquid crystal material may be included. The liquid crystal material will aligned according to the upper alignment or rubbing direction 124 and the lower alignment or rubbing direction 126. In FIG. 54, the liquid crystal cell 114 is shown between the polarizers 116, 118. In one embodiment of the present invention, the upper alignment or rubbing direction 124 is parallel to the polarization axis of the upper polarizer 116 and the lower alignment or rubbing direction 126 is parallel to the polarization axis of the lower polarizer 118.

The actual rub directions of the liquid crystal cells may be adjusted depending on the swept back angle and tilt angle of the shutters relative to the user's face to obtain maximum contrast. These values can be determined experimentally, if desired. Also, the liquid crystal shutter 90 may be cut to obtain the desired angles such as those shown, using various known manufacturing techniques used to cut liquid crystal cells.

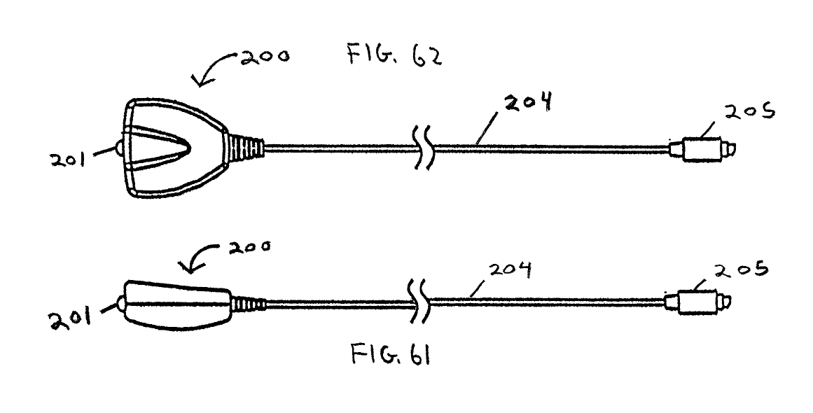

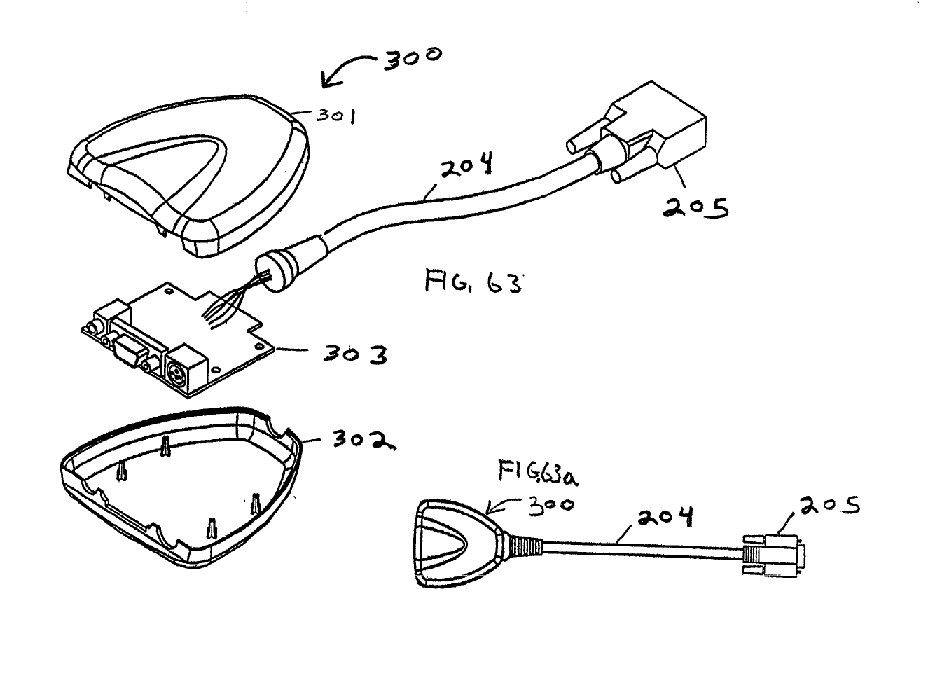

The transmitter 200 shown in FIGS. 55-62, 64-67 and 67a includes circuitry to operate an infra-red (IR) emitting device 201 for use to cause operation of shutter glasses. IR emitting devices are known and are described, for example, in copending US patent application entitled METHOD AND APPARATUS FOR VIEWING STEREOSCOPIC THREEDIMENSIONAL IMAGES. The entire disclosure of such patent application is incorporated by this reference. The bottom surface 202 of the transmitter 200 is curved with Velcro™ tape 203 (a hook and loop fabric material or another suitable material) applied to the transmitter bottom. Matching Velcro™ tape is applied to a surface on which the transmitter is to be mounted. The direction of emission of the IR can be adjusted laterally and vertically due to the curvature of the transmitter bottom and the use of the Velcro™ tape. The transmitter 200 is connected to a display via a cable 204 and connector 205.

FIGS. 63 and 63a show another transmitter or circuit device 300 sometimes referred to as a dongle. The device 300 includes a clam shell 301, 302 that can be coupled directly in a cable 204 and house a circuit 303. The cable 204 can be coupled to a computer or other signal source to cooperate with the shutter glasses 10 to operate the same.

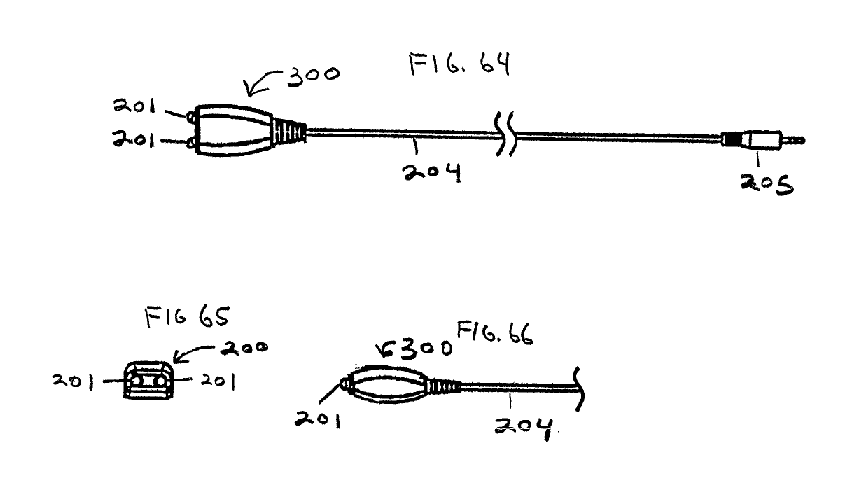

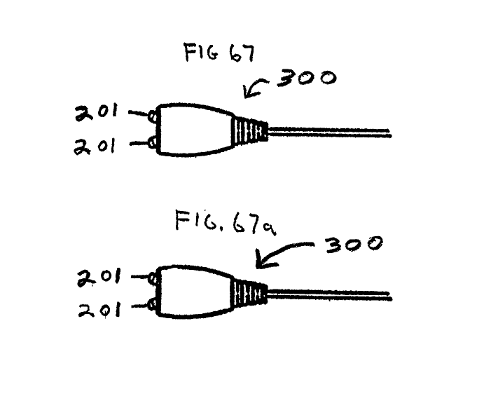

FIGS. 64, 65 and 66 show respectively show a top, front and side view of a dongle having two IR emitting devices 201. The two IR emitting devices 201 improve the field of view of the shuttered glasses 10.

I claim:

1. Head mountable frame for light shutters for viewing of images, comprising
a retainer mechanism to retain a light shutter mechanism,
a cavity in the frame for a circuit to provide for operation of a light shutter, and
a closure for the cavity to retain a circuit.

2. The frame of claim 1, wherein the closure comprises tape.

3. The frame of claim 1, wherein the closure comprises a tape-like material for closing the cavity and for cooperating with the retainer mechanism to retain a light shutter mechanism with respect to the frame.

4. The frame of claim 1, wherein the closure comprises a bar that fits to the cavity to retain a circuit in the cavity.

5. The frame of claim 1, further comprising a circuit in the cavity, the circuit including wires.

6. The frame of claim 5, wherein the retainer mechanism comprises a pair of openings for retaining respective light shutters and the wires are connectable to respective light shutters.

7. The frame of claim 5, further comprising a strain relief in the frame to retain the wiring with respect to the frame.

8. The frame of claim 7, wherein the strain relief comprises openings in the frame for passage of the wiring in a loop with a sufficiently close spacing of the wiring to provide a secure frictional gripping of the wiring in response to tension applied to the wiring.

9. The frame of claim 7, wherein the strain relief comprises a number of bar-like protrusions on the frame for passing wiring therebetween.

10. The frame of claim 9, further comprising adhesive for adhering the wiring to the bar-like protrusions.

11. The frame of claim 1, further comprising a strain relief to retain with respect to the frame wiring to provide for operation of light shutters, the strain relief including at least two openings for threading of wiring therethrough to provide for relatively sharp bends in the wiring to resist pulling of the wiring through the openings while transmitting pull force directly to the frame.

12. A viewing apparatus for viewing stereoscopic images, comprising
a mounting frame for wearing on the head of a person,
a pair of light shutters in the mounting frame,
circuitry to provide signals to the light shutters for operating the shutters,
a cavity in the mounting frame for at least part of the circuitry, and
a closure for the cavity to retain the circuitry.

13. The apparatus of claim 12, wherein the closure is tape.

14. The apparatus of claim 13, Wherein the tape also provides for retaining the light shutters in the mounting frame.

15. The apparatus of claim 12, wherein the closure is a bar.

16. The apparatus of claim 15, wherein the bar includes a portion to cover at least part of the cavity to retain the circuitry therein, and also includes respective portions to provide for retaining the light shutters in the mounting frame.

17. The apparatus of claim 12, wherein the circuitry comprises wires for coupling signals to respective light shutters.

18. The apparatus of claim 17, wherein the circuitry includes a circuit board.

19. The apparatus of claim 12, further comprising wiring for coupling externally derived signals to the circuitry or to the light shutters.

20. The apparatus of claim 19, further comprising a strain relief in the mounting frame to retain the wiring with respect to the mounting frame.

21. The apparatus of claim 20, wherein the strain relief comprises openings in the mounting frame for passage of the wiring in a loop with a sufficiently close spacing of the wiring to provide a secure frictional gripping of the wiring in response to tension applied to the wiring.

22. The apparatus of claim 12, wherein the frame is eyewear, including temple pieces, an area for the nose of a user, and wherein the retainer mechanism comprises a pair of openings for retaining respective light shutters in position relative to the eyes of a user to control images provided to the eyes.

23. The apparatus of claim 12, wherein the light shutters comprise electro-optical light shutters having terminals, a cavity in the mounting frame for placement of the terminals with space for wiring connections to the terminals to provide for operation of the light shutters.

24. The apparatus of claim 12, wherein the mounting frame has openings for the light shutters, and further comprising tab retainers for retaining the light shutters in the openings.

25. The apparatus of claim 24, wherein the tab retainers include a pair of walls, one of the walls comprising a flange extending generally in parallel with a light shutter and the other wall spacing the flange away from the major portion of the mounting frame.

26. The apparatus of claim 25, wherein the openings have walls about at least a portion thereof extending generally in parallel with a light shutter for cooperating with tab retainer walls to retain a light shutter in a respective opening.

27. The apparatus of claim 26, further comprising tape covering a portion of each light shutter to retain the light shutter in the opening.

28. The apparatus of claim 26, further comprising a bar covering a portion of each light shutter to retain the light shutter in the opening.

29. The apparatus of claim 12, wherein the mounting frame has a non-planar, wrap-around shape.

30. The apparatus of claim 12 or 29, wherein the light shutters and openings in the mounting frame are non-rectangular.

31. The apparatus of claim 30, wherein the light shutters and openings are pentagonal.

32. The apparatus of claim 31, wherein the light shutters and openings have at least two right angle corners.

33. The apparatus of claim 32, wherein the light shutters are twisted nematic liquid crystal cells rubbed to provide rub direction axes other than parallel or perpendicular to walls adjoining such right angle corners.

34. The apparatus of claim 30, wherein the light shutters are twisted nematic liquid crystal cells rubbed to provide rub direction axes other than parallel or perpendicular to walls adjoining such right angle corners, such rub directions being oriented relative to the viewing direction through the light shutters to provide good contrast including substantially maximum dark condition with substantially minimal light leakage occurring in the light blocking mode

35. The apparatus of claim 34, wherein the light shutters are positioned in the mounting frame as to be generally non-perpendicular to the direction of viewing through the light shutters.

36. The apparatus of claim 34, wherein the rub directions of respective surfaces of a twisted nematic liquid crystal cell are perpendicular to each other.

37. The apparatus of claim 12, further comprising a strain relief to retain with respect to the frame wiring to provide for operation of light shutters, the strain relief including at least two openings for threading of wiring therethrough to provide for relatively sharp bends in the wiring to resist pulling of the wiring through the openings while transmitting pull force directly to the frame.

38. The apparatus of claim 12, further comprising a strain relief to retain with respect to the frame wiring to provide for operation of light shutters, wherein the strain relief comprises a number of bar-like protrusions on the frame for passing wiring therebetween.

39. The apparatus of claim 38, further comprising adhesive for adhering the wiring to the bar-like protrusions.

40. The apparatus of claim 12, wherein the mounting frame includes temple pieces, the circuitry comprising wiring connection to an external electrical source, and a clip slidable on a temple piece for clipping wiring with respect to the temple piece to hold the wiring in generally parallel relation with at least a portion of the temple piece and to determine the location along the temple piece where the wiring is released from substantially parallel relation.

41. The apparatus of claim 40, further comprising a strain relief for retaining the wiring relative to the mounting frame substantially independently of the clip.

42. A viewing apparatus for viewing stereoscopic images, comprising
a mounting frame for wearing on the head of a person,
a pair of light shutters in the mounting frame,
circuitry to provide signals to the light shutters for operating the shutters, and wherein the mounting frame has a non-planar, wrap-around shape.

43. The apparatus of claim 42, wherein the light shutters and openings in the mounting frame are non-rectangular.

44. The apparatus of claim 43, wherein the light shutters and openings are pentagonal.

45. The apparatus of claim 43, wherein the light shutters and openings have at least two right angle corners.

46. The apparatus of claim 45, wherein the light shutters are twisted nematic liquid crystal cells rubbed to provide rub direction axes other than parallel or perpendicular to walls adjoining such right angle corners.

47. The apparatus of claim 42, wherein the light shutters are twisted nematic liquid crystal cells rubbed to provide rub direction axes other than parallel or perpendicular to walls adjoining such right angle corners, such rub directions being oriented relative to the viewing direction through the light shutters to provide good contrast including substantially maximum dark condition with substantially minimal light leakage occurring in the light blocking mode

48. The apparatus of claim 42, wherein the light shutters are positioned in the mounting frame as to be generally non-perpendicular to the direction of viewing through the light shutters.

49. The apparatus of claim 42, wherein the rub directions of respective surfaces of a twisted nematic liquid crystal cell are perpendicular to each other.

50. A viewing apparatus for viewing stereoscopic images, comprising
a mounting frame for wearing on the head of a person,
a pair of light shutters in the mounting frame,
circuitry to provide signals to the light shutters for operating the shutters, and
further comprising a strain relief to retain with respect to the frame wiring to provide for operation of light shutters, the strain relief including at least two openings for threading of wiring therethrough to provide for relatively sharp bends in the wiring to resist pulling of the wiring through the openings while transmitting pull force directly to the frame.

51. A viewing apparatus for viewing stereoscopic images, comprising
a mounting frame for wearing on the head of a person,
a pair of light shutters in the mounting frame,
circuitry to provide signals to the light shutters for operating the shutters, and
further comprising a strain relief to retain with respect to the frame wiring to provide for operation of light shutters, wherein the strain relief comprises a number of bar-like protrusions on the frame for passing wiring therebetween.

52. The apparatus of claim 51, further comprising adhesive for adhering the wiring to the bar-like protrusions.

53. A viewing apparatus for viewing stereoscopic images, comprising
a mounting frame for wearing on the head of a person,
a pair of light shutters in the mounting frame,
circuitry to provide signals to the light shutters for operating the shutters,
wherein the mounting frame includes temple pieces, the circuitry comprising wiring connection to an external electrical source, and a clip slidable on a temple piece for clipping wiring with respect to the temple piece to hold the wiring in generally parallel relation with at least a portion of the temple piece and to determine the location along the temple piece where the wiring is released from substantially parallel relation.

54. The apparatus of claim 53, further comprising a strain relief for retaining the wiring relative to the mounting frame substantially independently of the clip.

55. A transmitter housing for a device for transmitting electromagnetic energy to a receiver, the transmitter comprising
a housing for an electromagnetic energy transmitter,
the housing having a curved wall for supporting the housing,
a variable retainer at the curved wall for cooperation with a support surface to position the housing at various directional angles relative to such support surface.

56. The housing of claim 55, wherein the variable retainer is Velcro type material.

57. The housing of claim 56, wherein the Velcro type material is cooperative for retention in relatively fixed orientation thereof and of the housing with respect to such support surface.

58. The housing of claim 57, further comprising an electromagnetic energy emitter located with respect to the housing to provide an electromagnetic energy output in a direction based on the orientation of the housing with respect to the support surface.

59. The housing of claim 58, wherein the electromagnetic energy emitter is light emitting diode.

60. The housing of claim 59, wherein the electromagnetic energy emitter comprises a number of light emitting diodes.

61. The housing of claim 59, wherein the light emitting diode emits infrared light.

62. The housing of claim 57, wherein the electromagnetic energy emitter provides infrared light.

63. A stereoscopic eyewear system comprising:
eyewear for generating a three dimension image from a viewed two dimensional image using a reference signal; and
at least two transmission sources for generating the reference signal,
wherein the reference signal coordinates the eyewear to the two dimensional image, and
wherein each of the at least two transmission sources transmits to an area not covered by another of the at least two transmission sources.

64. The system of claim 63, wherein the at least two transmission sources are wireless transmission sources.

65. The system of claim 64, wherein the at least two transmission sources are infrared transmission sources.

66. The system of claim 63, wherein the eyewear includes two shutters.

67. The system of claim 66, wherein the two shutters are non-rectangular.

68. The system of claim 67, wherein the two shutters each have five sides.

69. The system of claim 67, wherein each liquid crystal shutter has an maximum contrast axis at about 10° from a top edge of the liquid crystal shutter.

70. The system of claim 66, wherein the two shutters are liquid crystal shutters.

71. The system of claim 63, wherein the at least two transmission sources are attachable to a surface such that a direction of transmission of the at least two transmission sources can be adjusted.

72. The system of claim 71, wherein the at least two transmission sources are housed in a curved housing at least partly covered with a material for attachment to another surface.

73. The system of claim 72, wherein the material for attachment to another surface is a hook and loop fabric material.

74. A stereoscopic eyewear system comprising:
eyewear for generating a three dimension image from a viewed two dimensional image using a reference signal, the eyewear including two shutters each having electrical connections;
a transmission line for conducting the reference signal to two shutters of the eyewear; and
at least one strain relief feature for relieving strain applied via the transmission line.

75. The system of claim 74, wherein the at least one strain relief feature includes a pair of guide bars.

76. The system of claim 75, further comprising an adhesive applied between the guide bars to secure the transmission line to the eyewear.

77. The system of claim 75, wherein the at least one strain relief feature further includes a transmission line loop.

78. The system of claim 74, wherein the at least one strain relief feature includes a transmission line loop.

79. The system of claim 74, wherein the transmission line is a cable that is enclosed in a cable way within the eyewear.

80. The system of claim 74, wherein the at least one strain relief feature relieves strain from the transmission line that might be applied to the electrical connections.

81. The system of claim 74, wherein the two shutters are non-rectangular.

82. The system of claim 81, wherein the two shutters each have five sides.

83. The system of claim 81, wherein the two shutters are liquid crystal shutters.

84. The system of claim 81, wherein each liquid crystal shutter has an maximum contrast axis at about 10° from a top edge of the liquid crystal shutter.
